(19) United States
(12) Patent Application Publication
(10) Pub. No.: US 2015/0075675 A1
(43) Pub. Date: Mar. 19, 2015

(54) METHOD AND TOOL FOR FORMING OF UNDERCUT GROOVES

(71) Applicant: Benny Andersson, Almhult (SE)

(72) Inventor: Benny Andersson, Almhult (SE)

(73) Assignee: IKEA Supply AG, Pratteln (CH)

(21) Appl. No.: 14/371,796

(22) PCT Filed: Jan. 20, 2012
(86) PCT No.: PCT/EP2012/050832

§ 371 Date: Oct. 13, 2014

(51) Int. Cl. B27F 1/02; B27B 33/02

(52) U.S. Cl. CPC B27F 1/02; B27B 33/02
USPC 144/371; 83/846; 83/851

(57) ABSTRACT

The present invention concerns a method for forming longitudinal undercut grooves in wood products. It also concerns a cutting blade (5, 12, 14, 15) that could be used in the method. According the invention a longitudinal straight groove (4) is formed in a wooden work piece (1) in a first step, for instance by means of a circular saw blade (2). In a second step the work piece (1) is moved pass the cutting blade (5, 12, 14, 15) to form an undercut groove (7, 8, 9, 10), which undercut groove is either symmetric or asymmetric. The cutting blade (5, 12, 14, 15) has a number of cutting heads (6). The cutting width of the cutting heads increase from a first cutting head (6a) to a last cutting head (6b).

### TECHNICAL FIELD

The present invention concerns a method and a tool for forming undercut grooves in wood or wood based products.

### BACKGROUND

In forming of undercut grooves, for instance in different types of plates, in the furniture industry today a rotating milling head is used. This method works well for grooves having relatively large dimensions. However, for grooves having a small width, the stem of the milling tool has a tendency to brake, due to the necessarily small dimension of the stem. To reduce the risk of breaking of the stem the relative travel speed between work piece and milling tool is normally kept low. A low relative travel speed increases the manufacturing time and it is therefore beneficial if the relative travel speed between work piece and the cutting tool can be increased.

The minimal width of the opening of an undercut groove produced by means of a rotating milling head is about 5 mm for a practical production speed.

### SUMMARY

One object of the present invention is to increase the possible relative travel speed between tool and work piece in production of undercut grooves. Expressed in another way the manufacturing (production) time is decreased.

One further object is that the shavings or chips formed during the cutting should be transported away in a proper and suitable way. If the shavings are not transported away in a proper way the maximal feeding speed will be limited. Further, breaking of the shavings is beneficial to transport the shavings away.

Still a further object is to be able to form an undercut groove having an opening width of down to about 2 mm at a practical production speed.

Still a further object is to be able to form undercut grooves of any form, for example undercut grooves having an asymmetric geometry.

According to the present invention a method for forming an undercut groove in a wood product is developed. In a first step a longitudinal straight groove is formed. In a second step the longitudinal straight groove is formed into an undercut groove. According to a further aspect of the present invention a cutting blade has been developed to form a longitudinal undercut groove in a wood product. The cutting blade has a number of cutting heads with cutting edges. The width of the cutting heads increase from a first cutting head to a last cutting head.

Even though the present invention has been developed for undercut grooves having a small opening width, a person skilled in the art realises that it may be used also for undercut grooves having any opening width.

Further objects and advantages of the present invention will become obvious for a person skilled in the art when reading the detailed description below.

### BRIEF DESCRIPTION OF THE DRAWINGS

The invention will be described further below by way of examples and with reference to the enclosed drawings. In the drawings:

FIG. 1 illustrates a first step in forming undercut grooves according to one embodiment of the present invention,

FIG. 2 illustrates a second step in forming undercut grooves according to one embodiment of the present invention and also a first embodiment of a cutting blade according to the present invention,

FIGS. 3a to 3d show some examples of undercut grooves that could be formed with a method and tool according to the present invention,

FIG. 4 shows an alternative saw blade to be used in a first step according to one embodiment of the present invention,

FIG. 5 shows a combined saw and cutting blade according to one embodiment of the present invention, and

FIGS. 6a and 6b show a further alternative method in forming undercut grooves according to the present invention and a combined cutting blade according to one embodiment of the present invention.

### DETAILED DESCRIPTION

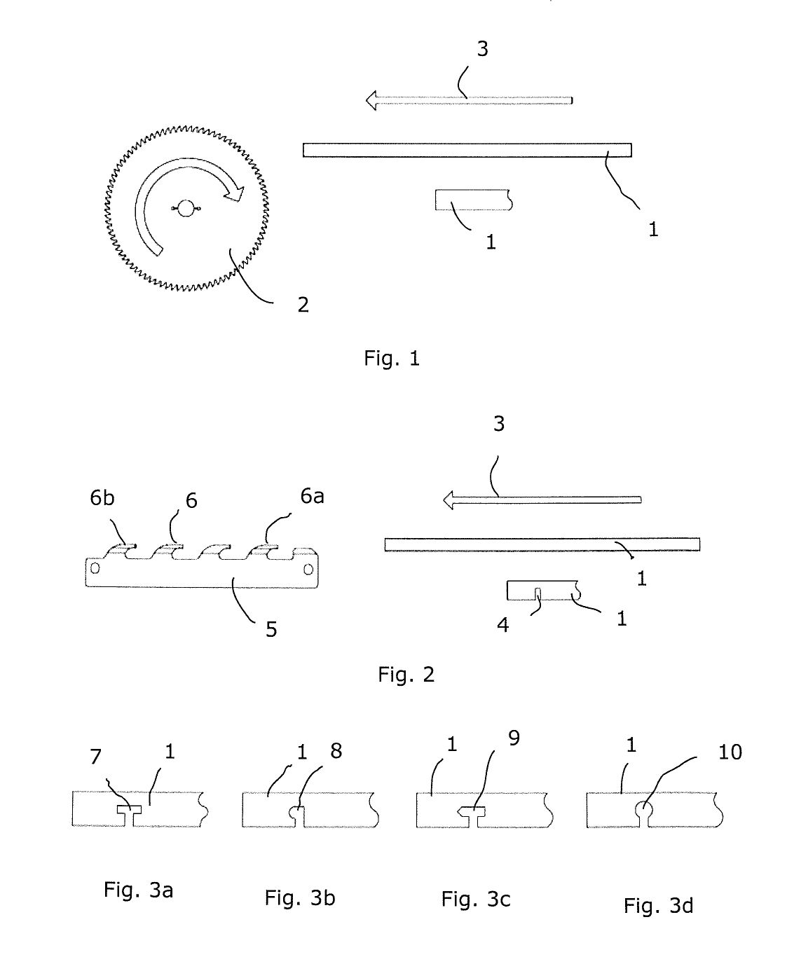

In a first step in forming an undercut groove according to one embodiment of the present invention, a work piece 1 is moved over a circular saw blade 2. In FIGS. 1 and 2 the work piece 1 is shown both in end view and side view. The end view of the work piece 1 is placed below the side view. The work piece 1 is shown in FIG. 1 before reaching the circular saw blade 2. The arrow indicates the travel direction 3 for the work piece 1. FIGS. 1 and 2 indicate that the work piece 1 is moved towards the circular saw blade 2, which is the normal way in industrial production. However, as the only criteria is that there is a relative movement between the work piece 1 and the saw blade 2, the saw blade 2 may move and the work piece 1 stand still or both saw blade 2 and work piece 1 may move towards each other.

After the first step the work piece 1 will have a longitudinal straight groove 4, formed by the rotating saw blade 2. The longitudinal straight groove 4 has a rectangular cross section with one open side, as seen in end view. In the second step the work piece 1 will pass over a cutting blade 5, which cutting blade 5 is received in the longitudinal straight groove 4. The cutting blade 5 has a number of cutting heads 6. The cutting heads 6 have cutting edges at a height corresponding with the position of an undercut groove to be formed in the work piece 1. Each cutting head 6 may have one or two cutting edges. If each cutting head 6 has one cutting edge the cutting edges may be directed in opposite directions for every second cutting head 6. For cutting blades 5 having cutting heads 6 with cutting edges on only one side, the cutting edges may be directed in opposite direction for every second cutting head 6, as seen in longitudinal direction. For cutting heads 6 having two cutting edges, the cutting edges are directed in directions opposite each other. Thus, depending on the form of the undercut groove to be formed the cutting edges of the cutting heads 6 are either directed in only one direction or in opposite directions.

The cutting blade 5 has a first cutting head 6a, which is the first cutting head to enter the longitudinal straight groove 4 of the work piece 1. The cutting blade 5 has also a last cutting head 6b, which is the last cutting head to enter the longitudinal straight groove 4 of the work piece 1. The number of cutting heads 6 on the cutting head can vary extensively and there is no exact limitation on the number of cutting heads 6. The cutting width of the cutting heads 6 increases from the first cutting head 6a to the last cutting head 6b. Thus, the width of the undercut groove is increased somewhat for each passing cutting head 6. The cutting width for the cutting heads 6 having two cutting edges in opposite directions is taken between the cutting edges. For cutting heads 6 having only one cutting edge the cutting width is taken from the cutting edge to a position of the cutting head corresponding with the centre of the longitudinal groove 4. The amount the cutting width of the cutting heads 6 increases depend on a number of factors, such as the material of the work piece 1, the desired relative travel speed of the work piece 1, the form of the undercut groove and the number of cutting heads 6 on the cutting blade 5. By increasing the number of cutting heads 6 the difference in cutting width of two adjacent cutting heads 6 may be decreased. A small difference in cutting width means that each cutting edge will only take away a small amount of material.

A person skilled in the art realizes that in production the rotating saw blade 2 and the cutting blade 5 are normally placed adjacent each other. Thus, the work piece 1 will first move over the rotating saw blade 2 and there after over the cutting blade 5 in the same movement.

Depending on the desired form of the undercut grove, each cutting head 6 may have a cutting edge on only one side or on both sides. In other embodiments every second cutting head 6 has a cutting edge on one side and the other cutting heads have a cutting edge on the opposite side.

In FIGS. 3a to 3d four examples of undercut grooves 7-10 are shown. The undercut groove 7 of FIG. 3a is identical on both sides of the original longitudinal straight groove 4. The undercut groove 8 of FIG. 3b is only cut on one side of the original longitudinal straight groove 4. The undercut groove 9 of FIG. 3c is cut in different forms on the alternate sides of the original longitudinal straight groove 4. The undercut groove 10 of FIG. 3d has a circular section form. As these examples show, the undercut groove may have many different forms and do not have to be symmetrical. A person skilled in the art realises that the shape of the undercut grooves may have many other forms than those shown in the Figs.

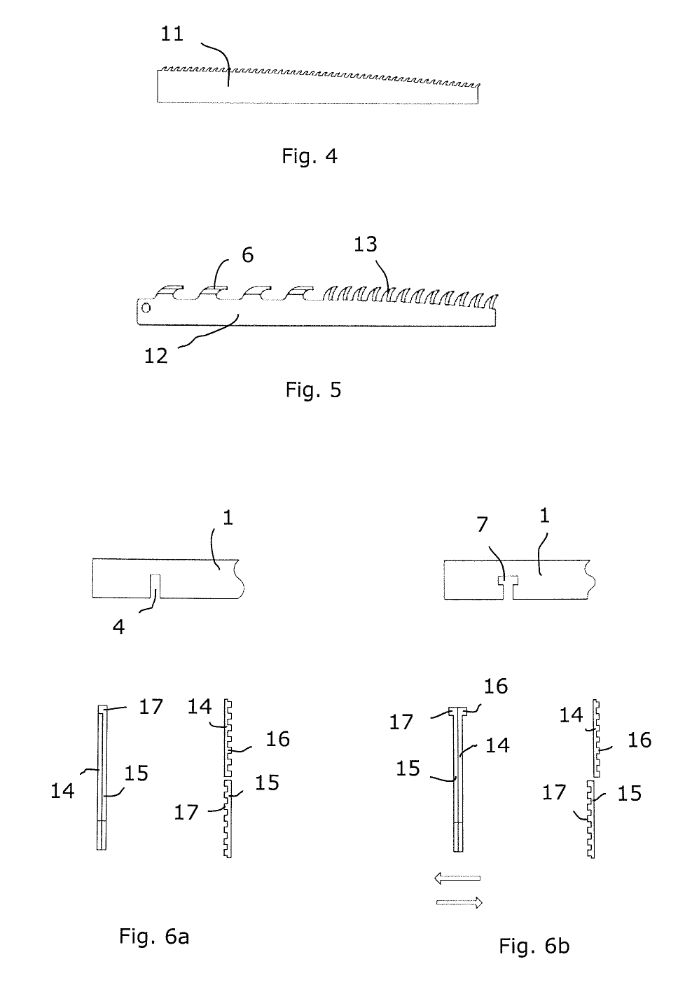

Instead of forming the longitudinal straight groove 4 with a circular saw blade 2, a straight saw blade may be used. In FIG. 4 one example of such a straight saw blade 11 is shown. The straight saw blade 11 has a number of teeth to form a longitudinal groove 4.

In FIG. 5 a cutting blade 12 is shown having both saw teeth 13 and cutting heads 6. By means of the saw teeth 13 the longitudinal groove 4 is formed. The cutting heads 6 will then form an undercut groove. Thus, by the cutting blade 12 as shown in FIG. 5, only one blade is needed to form a complete undercut groove.

In FIGS. 6a and 6b a further example of a cutting tool is shown, which cutting tool is combined of two cutting blades 14, 15. Each cutting blade 14, 15 may have a form corresponding with the cutting blade 12 of FIG. 5. To form the longitudinal straight groove 4 the cutting blades 14, 15 are placed in line with each other, as indicated in FIG. 6a. To form an undercut grove the cutting blades are displaced from one another and no longer are placed in line with each other, as indicated in FIG. 6b. By the displacement of the cutting blades 14, 15 cutting heads 16, 17 of respective cutting blade 14, 15 are placed to form an undercut groove 7. The cutting heads 16, 17 are placed on the appropriate height for forming the desired undercut groove 7. Thus, the same tool may be used for forming both the original longitudinal straight groove 4 and the undercut groove 7. In the same way as indicated above the form of the undercut groove 7 depends on the form of the cutting heads 16, 17. Thus, by altering the form and or size of the cutting heads 16, 17 the form and size of the undercut groove is altered, as seen in cross section.

With the combined cutting tool of FIGS. 6a and 6b, it is relatively easy to form an undercut groove 7 only along parts of a work piece 1, by simply move the cutting blades 14, 15 towards or away from each other. By the movement of the cutting blades 14, 15 the cutting heads 16, 17 of respective cutting blade 14, 15 is moved into or out of an active cutting position.

As each cutting head 6 only takes away a small amount of material the relative travel speed between work piece 1 and cutting tool 5 can be held relatively high without extensive heating of work piece 1 or cutting tool 5. One possible relative travel speed between work piece 1 and cutting tool 5 is about 2000 m/min.

The method and tool of the present invention may be used for longitudinal straight grooves having a width down to about 2 mm.

In some embodiments the cutting tool 5 is given a vibrating movement having a high frequency and low amplitude. By the vibrating movement the braking of the shavings is increased, which improves transportation of the shavings and makes it possible to increase the relative feeding speed between the cutting tool and the work piece 1. The frequency of the vibrating movement should be such that the cutting tool is moved with a speed exceeding the travel speed of the work piece 1. The vibrating movement is in one embodiment a motion back and forth in longitudinal direction. In another embodiment the vibrating movement is a first movement forward in longitudinal direction while the movement backwards has an arc form away from the work piece 1. By means of the arc form the cutting heads will not be in contact with the work piece in the movement backwards.

Normally the work piece 1 is moved to pass the cutting tool or cutting tools, but a person skilled in the art realizes that it is also possible to keep the work piece still and instead move the cutting tool or cutting tools. It is also possible to move both the work piece 1 and the cutting tool or cutting tools in opposite directions towards each other. In one cutting method the cutting tool or cutting tools are first moved from a starting point in a direction opposite to movement of the work piece 1. The cutting tool or cutting tools are moved to a turning point. When reaching the turning point the cutting tool or cutting tools are stopped and then moved in the opposite direction, i.e. the same direction as for the work piece 1. The cutting tool or cutting tools are moved at a higher speed than the work piece 1, and moves in that direction until the cutting tool or cutting tools have reached the starting point. At the starting point the cutting tool or cutting tools is stopped and then again moved in the direction opposite the moving direction of the work piece 1.

The vibration of the cutting tool or cutting tools and the method where the cutting tool or cutting tools are moved in a direction opposite the moving direction of the work piece 1, makes it possible to increase the feeding speed of the work piece 1 and helps in cutting the shavings or chips and transporting them away.

1. A method of forming an undercut groove in a wood product, whereby a longitudinal straight groove is formed in a first step and the longitudinal straight groove is formed into an undercut groove in a second step, wherein the wood product is moved pass a saw blade, forming the longitudinal straight groove, and a cutting tool, forming the undercut groove and that the cutting tool is given a vibrating movement.

2. (canceled)

3. (canceled)

4. The method of claim 1, wherein the undercut groove is formed by a number of cutting heads on the cutting blade and wherein the width of the cutting heads increase from a first cutting head to a last cutting head, whereby the first cutting head is the first cutting head to go into the longitudinal straight groove.

5. The method of claim 1, wherein in a first step the saw blade and the cutting tool is moved in opposite direction to the moving direction of the wood product, from a starting point to a turning point and wherein in a second step the saw blade and cutting tool are moved at a speed higher than the moving speed of the work piece back to the starting point, where after said first and second steps are repeated.

6. A cutting blade to be used in the production of a longitudinal undercut groove in a wood product, wherein the cutting blade has a number of cutting heads, which cutting heads have cutting edges and that the width of the cutting heads increase from a first cutting head to a last cutting head, that the cutting blade is formed of two cutting blades, and that the two cutting blades can be moved towards and away from each other, whereby the two cutting blades are place in a common longitudinal plane when moved toward each other.

7. The cutting blade of claim 6, wherein the cutting edges of the cutting heads are placed symmetrical, to form a symmetrical undercut groove.

8. The cutting blade of claim 6, wherein the cutting edges of the cutting heads are placed asymmetrical to form an asymmetrical undercut groove.

9. The cutting blade of claim 6, wherein a number of saw teeth are placed in front of the cutting heads of the cutting blade.

10. (canceled)

11. The cutting blade of claim 6, wherein the two cutting blades are placed displaced from each other in a longitudinal direction.

12. The method of claim 1, wherein the vibrating movement is given as a motion back and forth in a longitudinal direction.

13. The method of claim 1, wherein the vibrating movement is given as a first movement forward in a longitudinal direction followed by a movement backwards in an arc form away from the wood product.
